(19) United States
(12) Patent Application Publication
(10) Pub. No.: US 2013/0021337 A1
(43) Pub. Date: Jan. 24, 2013

(54) METHOD, COMPUTER PROGRAM AND SYSTEM FOR COMPUTER-BASED EVALUATION OF IMAGE DATASETS

(71) Applicants: Thomas Blum, Neunkirchen A. Br (DE); Karoly Kiss, Herzogenaurach (DE); Christian Köglmeier, Nurnberg (DE)

(72) Inventors: Thomas Blum, Neunkirchen A. Br (DE); Karoly Kiss, Herzogenaurach (DE); Christian Köglmeier, Nurnberg (DE)

(73) Assignee: SIEMENS AKTIENGESELLSCHAFT, Munich (DE)

(21) Appl. No.: 13/552,085

(22) Filed: Jul. 18, 2012

(30) Foreign Application Priority Data
Jul. 19, 2011 (DE) 102011079380.1

(51) Int. Cl. G06T 15/00

(52) U.S. Cl. 345/419

(57) ABSTRACT

A method is disclosed for computer-based evaluation of a basic image dataset including a number of image slices on an evaluation device. In at least one embodiment, at least one three-dimensional reconstruction dataset is determined from the basic image dataset by way of the evaluation device, wherein within the framework of an evaluation application of multiplanar reconstruction for a requested presentation of the reconstruction dataset in an original image layer plane, the corresponding unprocessed slice image of the basic image dataset is displayed and at least one image processing tool applied within the framework of the multiplanar reconstruction is applied to the three-dimensional reconstruction dataset.

### PRIORITY STATEMENT

The present application hereby claims priority under 35 U.S.C. §119 to German patent application number DE 10 2011 079 380.1 filed Jul. 19, 2011, the entire contents of which are hereby incorporated herein by reference.

### FIELD

At least one embodiment of the invention generally relates to a method for computer-based evaluation of a basic image dataset comprising a number of image slices, especially a magnetic resonance image dataset, on an evaluation device, wherein at least one three-dimensional reconstruction dataset, especially magnetic resonance reconstruction dataset, suitable for multiplanar reconstruction is determined from the basic image dataset by way of the evaluation device, and/or to a computer program and/or a system for computer-based evaluation.

### BACKGROUND

Multiplanar reconstruction (often also called multiplanar reformation) (MPR) is a widely known method for two-dimensional image reconstruction. In this method two-dimensional slice or sectional images can be calculated in any given spatial orientation from an existing three-dimensional image volume. This method is used nowadays in almost all medical imaging modalities for image evaluation (image diagnosis), for example in computed tomography (CT), in magnetic resonance (MR), in Positron-Emission Tomography (PET), in SPECT, in other x-ray imaging techniques etc.

In order to obtain as few artifacts as possible by interpolation it is preferred for the volume (the reconstruction dataset) to consist of isotropic voxels. Isotropic voxels are voxels with the same spatial extent in all three spatial directions.

With magnetic resonance in particular this is no longer always guaranteed. Although three-dimensional imaging methods exist which generate isotropic voxels, magnetic resonance image datasets are frequently created in a two-dimensional technology in order to make a short measuring time possible. In such cases the resolution in the image plane (image slice plane) is mostly markedly greater than the resolution in the direction at right angles thereto (z direction), depending on the slice thickness and the slice spacing. For the creation of a magnetic resonance reconstruction dataset (volume) with isotropic voxels from these two-dimensional slice images the result in this case is extended interpolation artifacts in the z direction, for example through the addition of calculated intermediate slices to compensate for the slice thickness or the slice distance. If for example two-dimensional images are reconstructed from such a magnetic resonance reconstruction dataset orthogonally to the original image slice planes, very unsharp, interpolated images with what is known as “rod formation” are obtained. In the final analysis only images in planes which correspond to the original image slices are shown without interpolation artifacts.

The radiologists diagnosing, i.e. evaluating, the magnetic resonance image datasets generally do not accept the interpolated presentation with the artifacts, but prefer the presentation of the original two-dimensional slice images in the original image slices. The consequence of this however is that since the original magnetic resonance image dataset is used, three-dimensional image processing tools, for example an image fusion or volume determination are not able to be used and have to be implemented subsequently extensively for the two-dimensional magnetic resonance image dataset containing the slice images. A comparison of the original two-dimensional slice images with the images able to be shown in three dimensions in multiplanar reconstruction, for example PET images, is only possible to a limited extent.

Nowadays it is usual for the interpolation artifacts to be accepted and the usual multiplanar reconstruction to be applied also to magnetic resonance image datasets with slice images. The evaluating personnel in particular view this as a significant restriction.

It has also been proposed that the use of multiplanar reconstruction be avoided for these types of magnetic resonance image data sets. This is because by contrast for example with computed tomography, image slices can be recorded in magnetic resonance in almost any given spatial orientation. By selecting suitable magnetic resonance protocol the image slices are recorded in the orientation in which they are subsequently needed for evaluation, especially for creating a medical diagnosis. It is then no longer necessary to use multiplanar reconstruction. The disadvantage of this however is that especially if the magnetic resonance image datasets are to be evaluated jointly with further image datasets which are almost exclusively presented with the aid of multiplanar reconstruction, a direct comparison of the magnetic resonance slice images in 2D with two-dimensional images reconstructed from the reconstruction dataset of the further image datasets and the use of the same image processing tools, especially of evaluation tools and manipulation tools, is only possible to a very limited extent.

Should image processing tools which are able to be used for multiplanar reconstruction also be able to be applied to two-dimensional slice images of the magnetic resonance image data set, all functionalities must be generated twice as program segment/module and/or hardware, so that a larger footprint of the evaluation application is produced, meaning that a very large amount of memory is needed. At runtime of the evaluation application data must if necessary be stored multiple times and double the load is imposed on the CPU. Thus an approach to a solution of this type is not tailored to the computing power currently available.

### SUMMARY

The inventors recognize that the problems mentioned here are also conceivable for other basic image datasets, especially when the resolution is different in different directions.

At least one embodiment of the invention specifies an option, with reduced technical requirements for an evaluation device and lower overall effort, on the one hand to allow a presentation of the original basic image data and simultaneously the use of image processing tools available within the framework of multiplanar reconstruction.

At least one embodiment of the invention makes provision, within the framework of an evaluation application of multiplanar reconstruction
in a requested presentation of the reconstruction dataset in an original image slice plane, for the corresponding unprocessed slice image of the basic image datasets to be displayed; and
for at least one image processing tool employed within the framework of multiplanar reconstruction to be applied to the three-dimensional reconstruction dataset.

A method of at least one embodiment of the present invention also relates to a computer program which carries out at least one embodiment of the inventive method when executed. This computer program can typically be present on one or more data media and comprise a number of program segment/module overall which form the evaluation application. All statements in relation to at least one embodiment of the inventive method can be similarly transferred to the computer program, with which the stated advantages can thus also be achieved.

Finally the invention also relates to a system for computer-based evaluation of image datasets comprising at least one evaluation device and embodied for executing at least one embodiment of the inventive method. The remarks relating to the inventive system also apply to the inventive method, with such a system for computer-based evaluation also able to comprise further computing devices in addition to the evaluation device.

### BRIEF DESCRIPTION OF THE DRAWINGS

Further advantages and details of the present invention emerge from the exemplary embodiments described below as well as with reference to the drawing, in which:

FIG. 1 shows an inventive system for computer-based evaluation of image datasets,

FIG. 2 shows the basic structure of an evaluation application, and

FIG. 3 shows a diagram for native mode of multiplanar reconstruction.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed below, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks will be stored in a machine or computer readable medium such as a storage medium or non-transitory computer readable medium. A processor(s) will perform the necessary tasks.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments may be described with reference to acts and symbolic representations of operations (e.g., in the form of flowcharts) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs) computers or the like.

Note also that the software implemented aspects of the example embodiments may be typically encoded on some form of program storage medium or implemented over some type of transmission medium. The program storage medium (e.g., non-transitory storage medium) may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The example embodiments not limited by these aspects of any given implementation.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

At least one embodiment of the invention makes provision, within the framework of an evaluation application of multiplanar reconstruction
in a requested presentation of the reconstruction dataset in an original image slice plane, for the corresponding unprocessed slice image of the basic image datasets to be displayed; and
for at least one image processing tool employed within the framework of multiplanar reconstruction to be applied to the three-dimensional reconstruction dataset.

Thus, using at least one embodiment of the inventive method, especially for the case of a magnetic resonance image dataset with two-dimensional slice images having a large slice thickness or a slice distance, ultimately a specific mode is made available which on the one hand also makes an MPR volume available, thus the interpolations, but on the other hand, at least when the currently requested orientation corresponds to an original image slice, only displays the original image data, including the slice images of the basic dataset, especially of the magnetic resonance image dataset and thus makes the material available to the person carrying out the evaluation who wishes to assess this.

Since it is known in the application that the corresponding interpolated views of the reconstruction dataset frequently greatly affected by artifacts, as mentioned at the start, are not desirable, an especially advantageous embodiment of the inventive method makes provision that for a requested presentation outside an original image slice plane, a presentation of a slice image of the basic image dataset is undertaken in an original image slice plane, especially an image slice plane lying closest geometrically to the requested presentation plane or the last presented image slice plane or that no presentation is undertaken. This means that in this specific embodiment it is automatically ensured right from the start that only the native, artifact-free actual two-dimensional slice images of the basic image dataset, especially of the magnetic resonance image dataset, are displayed. For realization a scene graph data structure can be used for this purpose for example for the magnetic resonance reconstruction dataset, of which the camera position is restricted to the camera positions corresponding to the original image slices. It should be noted that of course a scene graph for the reconstruction dataset and further reconstruction datasets used within the framework of multiplanar reconstruction can generally be used.

Nonetheless it should be noted at this point that it is also possible that a user switches between an operating mode in which only the slice images of the basic image datasets are presented and an operating mode in which additionally interpolated slices determined from the reconstruction dataset are able to be displayed. This means an operating element can be provided by which each user can select the presentation variants which are better for them, wherein however it is still ensured by the inventive method that in this case, for the orientations corresponding to the original recording slices, the original non-interpolated two-dimensional slice images of the basic image dataset will be shown. However an automatic switchover between the operating modes based on predetermined criteria is also conceivable.

Thus, provided the two-dimensional image stack used within the framework of multiplanar reconstruction corresponds to the original orientation of the recorded two-dimensional slice image stack of the basic image dataset, the original slice images are also displayed. It is possible however, on leaving this orientation and choosing a specific operating mode, as presented above to also display reconstructed slices from the three-dimensional volume of the reconstruction dataset.

Thus, if the camera position is set to the orientation of the native image slices in the basic image dataset, “scrolling” through the two-dimensional slice images (parallel shift) and a rotation in the image slice plane (in-plane rotation) is possible, a rotation out of the original image slice can be avoided however.

At least one embodiment of the inventive method thus makes it possible overall to realize the two-dimensional presentation of the original slice images of the basic image dataset in an operating mode for multiplanar reconstruction in that the camera position for presenting the selected slice is restricted to the native orientation of the two-dimensional image slices. A paradigm is violated, since the two-dimensional and three-dimensional image processing is only available separately in many image systems, but within the framework of the inventive method through the described “MPR native mode” the advantages of multiplanar reconstruction and the presentation of the original slice images can be combined.

The advantages resulting from this are that, if only the original slice images can be presented, interpolation in the presentation in the original orientation of the image slices is omitted. The user is given the impression of a two-dimensional presentation like the one that they know from two-dimensional slice images of the basic image datasets, however the advantages of a three-dimensional MPR mode are available, such as the image processing tools for example, which can also be applied without modification to the native two-dimensional presentation of the slice images of the basic dataset.

In such cases, within the framework of a parallel shift action, as has been described above, there can be provision that, in a parallel shift action arranged by a user, at a specific position perpendicular to the planes of the original image slices, the slice image lying closest to the current position in its image slice plane will be presented. There can thus be provision for a slice image to be displayed provided the desired position is located perpendicular to the original image slice within the image slice or at least lies closer to the image slice than it does to other image slices. Only when this changes will there be switchover to the next valid image slice, thus to the next native slice image.

In an especially advantageous embodiment of the present invention there can be provision for at least one further image dataset recorded with a further imaging modality, especially a computed tomography image dataset and/or a PET image dataset and/or a magnetic resonance image dataset to be evaluated jointly with the basic image dataset, wherein a three-dimensional further reconstruction dataset fully usable within the framework of multiplanar reconstruction is determined from the further image dataset, wherein a presentation derived from the further reconstruction dataset is undertaken for each presentation plane required by the evaluation application. Such a further image dataset, for example an image dataset already available in any event as a three-dimensional image dataset such as PET image dataset, can thus be evaluated in parallel to the basic image dataset, for example the magnetic resonance image dataset, wherein the further image dataset is then considered in a normal operating mode for multiplanar reconstruction, in which basically the ultimate presentation, especially for all camera positions, is derived from the reconstruction dataset.

An inventive distinction of at least one embodiment can thus be made between a native mode for multiplanar reconstruction and a standard mode for multiplanar reconstruction, wherein then the reconstruction dataset assigned to the basic image dataset is stored in native mode and the further reconstruction dataset is stored in standard mode. In this case the embodiment is advantageously such that a program segment/module of the evaluation application controlling the image processing and/or presentation accesses both modes by the same interface. This therefore means that the image processing tools and the presentation tools, realized by program segment/module do not have to be specifically adapted, but that reconstruction data of the basic image dataset stored in native mode can be accessed with the unmodified program segment/module of the evaluation application. Thus the creation of this additional mode (MPR native mode) for the standard mode (MPR mode) means that complex additional programming of functionalities which are to be used for all image dataset types are not necessary.

In a further embodiment of the present invention there can be provision that, for a coupled presentation of basic image data and further data, if for a user-initiated joint rotation, a presentation outside the original image slice planes is requested for the basic image data and a slice image of an original image slice continues to be displayed, the deviation in the orientation of the presented images is brought to a user's attention.

If for example an operating mode of the evaluation application is provided in which the presented images of the jointly processed datasets will be jointly adapted by rotation and/or translation, and if a rotation from the original image slices is to take place without the display option for interpolated data of the reconstruction dataset being activated, this can be checked for example with reference to a dedicated program segment/module and the user can be informed about this state of affairs. For example it is possible if the joint presentation of a number of datasets is activated whenever it is guaranteed that the same orientation is present, to show a closed chain element which opens when the presented orientation deviates.

In a development of at least one embodiment of the present invention the evaluation application can comprise at least three programming layers, namely a presentation layer for interaction with the user, a business logic layer in which program segment/module for image processing and/or presentation, especially as a function of a user interaction detected in the interaction layer are stored and a service layer in which the access to program segment/module controlling image datasets and reconstruction datasets is held. The evaluation application can thus comprise three programming layers, in concrete terms a presentation layer which also contains the user interface, a business logic layer, which contains the application business logic, and a service layer in which the shared services, especially image processing including the modes for multiplanar reconstruction are realized. In this case an operating element, for example a menu entry can be provided in the user interface for example in order to activate or to deactivate the MPR native mode already explained.

In the business logic layer the business logic for the specific image manipulation an evaluation tools (image processing tools) is realized. The service layer contains the shared services and realizes the standard mode of multiplanar reconstruction for example in the form of a three-dimensional scene graft. The native mode of multiplanar reconstruction, which from the user's standpoint combines the advantages a two-dimensional mode (native presentation of the original image data) and a three-dimensional mode for multiplanar reconstruction, for example volume calculation, image fusion, is likewise realized in the service layer, for example as a supplement to the three-dimensional MPR scene graph.

The realization of the native mode (MPR native mode) in the service layer, especially in the scene graph, represents an advantageous example in which the image processing tools are not influenced by the expansion described here and can thus be used unchanged for the standard mode and the native mode of multiplanar reconstruction.

As already mentioned an evaluation tool, especially a volume determination tool and/or a movie tool and/or a manipulation tool, especially an image fusion tool can be used as the image processing tool. The plurality of known evaluation and manipulation tools for multiplanar reconstruction can now thus be applied without problems to two-dimensional slice images, without having to dispense with the view of the native slice images. Examples are evaluation tools which determine a volume within a three-dimensional reconstruction dataset, movie tools which for example can enable a stack of two-dimensional images to be run as a movie or manipulation tools, for example image fusion tools.

A method of at least one embodiment of the present invention also relates to a computer program which carries out at least one embodiment of the inventive method when executed. This computer program can typically be present on one or more data media and comprise a number of program segment/module overall which form the evaluation application. All statements in relation to at least one embodiment of the inventive method can be similarly transferred to the computer program, with which the stated advantages can thus also be achieved.

In concrete terms a computer program for multiplanar reconstruction of three-dimensional image datasets can be provided, which has as its operating modes a native mode for multiplanar reconstruction, in which a reconstruction image dataset suitable for multiplanar reconstruction determined from a basic image dataset comprising a number of image slices is stored and in which for a requested presentation of the reconstruction dataset in an original image slice plane, the corresponding unprocessed slice image of the basic image datasets is displayed, and a standard mode for multiplanar reconstruction in which a three-dimensional further reconstruction dataset fully usable within the framework of multiplanar reconstruction determined from a further image dataset is stored, with both modes having the same interface and the computer program further having at least one program segment/module controlling the image processing and/or presentation and accessing the native mode and the standard mode via the interface. A basically known computer program, hence an evaluation application for multiplanar reconstruction is thus expanded by a new operating mode, namely the native mode in which, with a corresponding interrogation, the original layer images not processed within the framework of determining the reconstruction dataset (i.e. unprocessed) are displayed. But this mode is now realized such that it offers the same interface as the standard mode. This makes possible program segment/module which realize image processing tools for example and which were determined for multiplanar reconstruction, yet also access the original slice images, so that only one set of program segment/module are thus needed. The common interface, as already described, can for example be realized by a scene graph which only allows specific camera positions.

The computer program can be held for example on a data medium such as a CD, a RAM of an evaluation device or a non-volatile storage medium.

Finally the invention also relates to a system for computer-based evaluation of image datasets comprising at least one evaluation device and embodied for executing at least one embodiment of the inventive method. The remarks relating to the inventive system also apply to the inventive method, with such a system for computer-based evaluation also able to comprise further computing devices in addition to the evaluation device.

There can be provision here in an advantageous embodiment that for realizing the evaluation application with at least three programming layers, namely an interaction layer for interaction with the user, a processing layer in which the program segment/module for processing and/or presenting, especially as a function of a user action detected in the interaction layer, are stored, and a service layer, in which the program segment/module controlling access to image datasets and reconstruction datasets are stored, a central evaluation device for executing the program segment/module of the processing layer and the service layer and at least one computing device communicating with the central evaluation device for executing the program segment/module of the interaction layer are provided. An architecture is then provided in which the business logic layer and the service layer are stored on a central evaluation device, for example a server, so that there can be access to them from a number of computing devices for example diagnostic workstations in order to carry out the corresponding evaluations. The CT evaluation workstation is then assigned a computing device which communicates with the central evaluation device and comprises the program segment/module of the presentation layer.

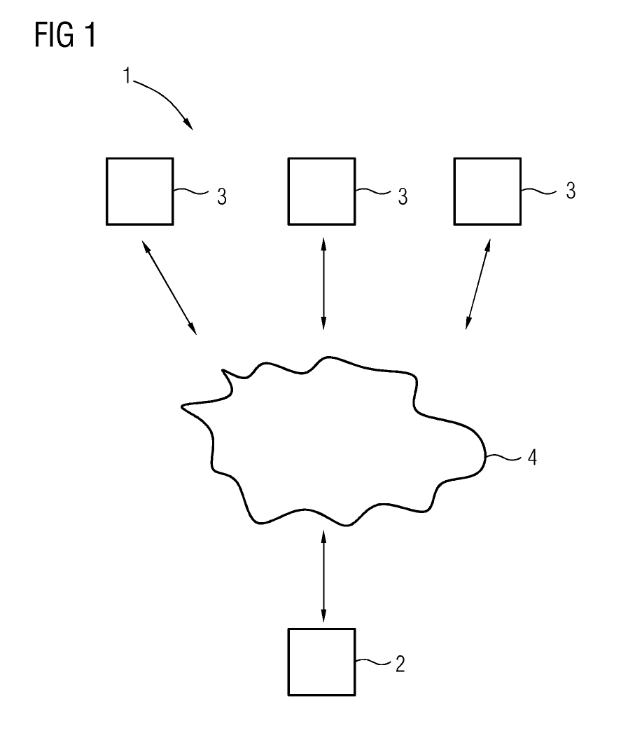

FIG. 1 shows the basic diagram of an embodiment of the inventive system 1 for computer-aided evaluation of image datasets. The figure shows a central evaluation device 2 provided as a server, with which various computing devices 3 at diagnostic workstations communicate, for example via a network 4, preferably an Intranet. The central evaluation device 2 can be connected to an image archiving system, for example a PACS, or can form part of such a system.

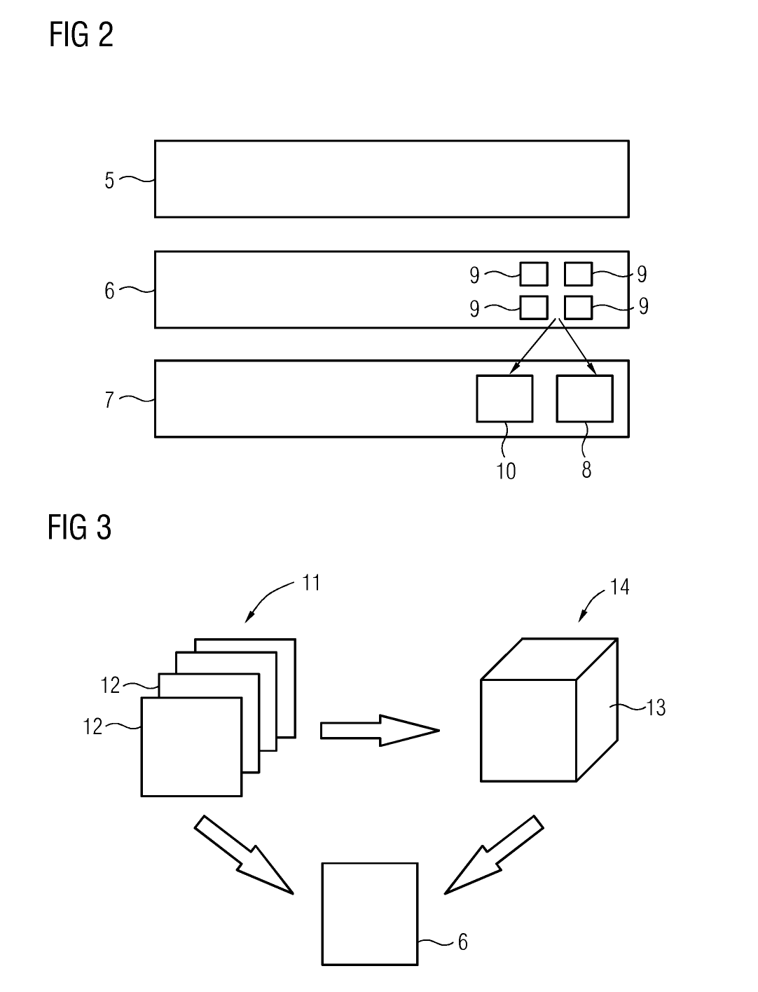

An embodiment of the inventive method can now be carried out with the aid of the system 1, meaning that an evaluation application is realized, as explained in greater detail by FIG. 2 for instance. FIG. 2 shows that the evaluation application has three programming layers, namely a presentation layer 5, a business logic layer 6 and a service layer 7. The presentation layer 5, which also contains the user interface, is realized in each case on the computing devices 3, while the business logic layer 6 and the service layer 7 are held on the central evaluation device 2, so that their program segment/module are executed on said device.

Since the evaluation application for multiplanar reconstruction is to be embodied within the framework of the evaluation for image datasets, a standard mode 8 for multiplanar reformation (MPR) is provided in the service layer 7. This standard mode ultimately creates from underlying image datasets, for example computed tomography image datasets or PET image datasets, a three-dimensional volume as reconstruction dataset, to which there can be access from the business logic level 6 by image processing tools 9, for example to compute image stacks in specific orientations from the three-dimensional volume or to undertake evaluations and manipulations, for example volume definitions and the like. This is all well known in the prior art and does not have to be explained in any greater detail here.

Specifically for magnetic resonance datasets (as basic image datasets) which contain a number of two-dimensional slice images with specific slice thicknesses and if necessary even slice distances, it is however not possible to create an artifact-free three-dimensional volume of a reconstruction dataset having isotropic voxels, i.e. voxels which will have the same extent in all spatial directions. The problem here is that the resolution in the image slice planes is greater than it is perpendicular to the image slice planes, which is thanks to the greater slice thickness or the distance between slices. Thus the user usually prefers to look at the two-dimensional slice images in a two-dimensional mode no longer provided in an embodiment of the inventive method in the service layer 7.

In order to make such magnetic resonance image datasets accessible to multiplanar reconstruction and its benefits, a native mode 10 for multiplanar reconstruction is now also provided in the service layer 7, which for example can be activated and deactivated via a menu entry in the user interface. In the example embodiment presented here, a three-dimensional magnetic resonance reconstruction dataset is actually also created in MPR native mode 10, with which the image processing tools 9 of the business logic layer 6 can interact as they do in relation to the standard mode 6. If however a presentation is requested the native mode 10 will basically return the native two-dimensional slice images of the magnetic resonance dataset here. Thus, although a three-dimensional volume is present in which interpolation has been undertaken, the two-dimensional slice images are still available for display as normal. The interpolation in the presentation is thus dispensed with but the image processing tools 9 (MPR tools), which include evaluation tools and manipulation tools, for example tools for volume measurement and image fusion are also able to be employed without said tools having to be modified, since the magnetic resonance reconstruction dataset is available for this case.

It should be pointed out once again at this juncture that the native mode 10 can also be realized so that the original slice images of the magnetic resonance image data set can be displayed when the orientation corresponds to the original image slices, but there is reference back to interpolated representations of the magnetic resonance reconstruction dataset if another orientation is present. If necessary a user can switch here between the two variants, with a native mode being preferred in that basically only the original two-dimensional slice images can be displayed, or there can be an automatic switchover between the variants based on predetermined criteria.

The standard mode 8 is realized here as a scene graph. The native mode 10 is now realized by an extension of the scene graph such that the camera position is restricted to the orientation of the native slice images, i.e. the original image slices. This means that within the framework of the MPR user interface a rotation in the plane of the slice images is thus possible however a rotation away from the native orientation of the image slices is prevented. When scrolling through the two dimensional slice images (parallel shift) the two-dimensional slice image of the magnetic resonance image dataset which lies closest to the current position in relation to the image slice is always shown.

FIG. 3 shows the principle of native mode 10 again in greater detail. A stack of two-dimensional native slice images 12 is available as the magnetic resonance image dataset 11. From this a three-dimensional volume 13, the magnetic resonance reconstruction dataset 14, is determined. Depending on a request from the business logic layer 6, the native mode 10 now delivers image data of the magnetic resonance image dataset 11 or information from the magnetic resonance reconstruction dataset 14. In contrast to this there is only recourse in the standard mode 8 to the reconstruction dataset.

It should be pointed out once again at this juncture that an embodiment of the present invention is also particularly suitable if at least one further image dataset recorded with a further imaging modality, for example a computed tomography image dataset or a PET image dataset, will be evaluated jointly with the magnetic resonance image dataset 11. In such cases the further image dataset, as originally described, is processed via the standard mode 8 of multiplanar reconstruction. The magnetic resonance image dataset 11 is processed via the native mode 10. Since, as described, the interface of both modes 8, 10, is identical, there is no difference between them for the program segment/module realizing the image processing tools 9.

In particular it is also possible in the example embodiment shown here, in relation to the presentation (orientation and position within the actual stack observed with the current camera alignment) to couple magnetic resonance data and the further data, wherein with a restriction of the camera position for the native mode 10, whenever the orientation presented deviates, this can be bought to the attention of a user, for example via two interlinked chain elements if the coupling is still intact and which separates from one another if for example there is a tilting away from the original image slice plane of the magnetic resonance image dataset 11.

Although the invention has been illustrated and described in greater detail by the example embodiment, the invention is not restricted by the disclosed examples and other variations can be derived from this by the person skilled in the art without departing from the scope of protection of the invention.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a tangible computer readable medium and is adapted to perform any one of the aforementioned methods when run on a computer device (a device including a processor). Thus, the tangible storage medium or tangible computer readable medium, is adapted to store information and is adapted to interact with a data processing facility or computer device to execute the program of any of the above mentioned embodiments and/or to perform the method of any of the above mentioned embodiments.

The tangible computer readable medium or tangible storage medium may be a built-in medium installed inside a computer device main body or a removable tangible medium arranged so that it can be separated from the computer device main body. Examples of the built-in tangible medium include, but are not limited to, rewriteable non-volatile memories, such as ROMs and flash memories, and hard disks. Examples of the removable tangible medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for computer-based evaluation, at an evaluation device, of an image dataset including a number of image slices, to determine at least one three-dimensional reconstruction dataset from the image dataset using the evaluation device within the framework of an evaluation application of the multiplanar reconstruction, the method comprising:
displaying, for a requested presentation of the reconstruction dataset in an original image layer plane, a corresponding unprocessed slice image of the image dataset; and
applying at least one image processing tool, applied within the framework of the multiplanar reconstruction, to the three-dimensional reconstruction dataset.

2. The method as claimed in claim 1, wherein, for a requested presentation outside an original image slice plane, a slice image of the image dataset in an original image slice plane is presented or no presentation is undertaken.

3. The method as claimed in claim 2, wherein, a scene graph data structure is used for the reconstruction dataset, camera positions of the scene graph data structure are restricted to camera positions corresponding to the original image slices.

4. The method as claimed in claim 2, wherein, for a parallel shift action arranged by the user at a position at right angles to the planes of the original image slices, the slice image lying relatively closest to the current position in the image layer plane is presented.

5. The method as claimed in claim 1, wherein at least one further image dataset recorded with a further imaging modality, wherein a further three-dimensional reconstruction dataset fully usable within the framework of multiplanar reconstruction is determined wherein, for each presentation plane requested by the evaluation application, a presentation is undertaken derived from the further reconstruction dataset.

6. The method as claimed in claim 5, wherein the reconstruction dataset assigned to the image dataset is stored in a native mode, the multiplanar reconstruction and the further reconstruction dataset are stored in a standard mode for multiplanar reconstruction, wherein a program segment/module of the evaluation application controlling at least one of the image processing and presentation accesses both modes via the same interface.

7. The method as claimed in claim 5, wherein, for a coupled presentation of the image data and further data, whenever a user-initiated joint rotation requests a presentation outside an original image slice plane for the image data and a slice image of an original image slice is still displayed, a user is notified of the deviation in the orientation of the images presented.

8. The method as claimed in claim 1, wherein the evaluation application comprises at least three programming layers including a presentation layer for interaction with a user, a business logic layer in which program segment/module for at least one of image processing and presentation in which program segment/module controlling access to image datasets and reconstruction datasets are stored.

9. The method as claimed in claim 1, wherein an evaluation tool is used as the image processing tool.

10. A computer readable medium including program segments for, when executed on a computer device, causing the computer device to implement the method of claim 1.

11. A computer program product for multiplanar reconstruction of three-dimensional image datasets, including a native mode for multiplanar reconstruction in which a reconstruction image dataset suitable for multiplanar reconstruction determined from a basic image dataset comprising a number of image slices is stored and in which for a requested presentation of the reconstruction dataset in an original image slice plane the corresponding unprocessed slice image of the basic image dataset is displayed, and a standard mode for multiplanar reconstruction, in which a three-dimensional further reconstruction dataset fully usable within the framework of multiplanar reconstruction determined from a further image dataset is realized, wherein both modes have the same interface and the computer program also has at least one program segment/module controlling at least one of image processing and presentation and accessing the native mode and the standard mode via the interface.

12. A system for computer-based evaluation of image datasets, comprising at least one evaluation device and embodied for carrying out a method as claimed in claim 1.

13. The system as claimed in claim 12, for realization of an evaluation application with at least three programming layers including a presentation layer for interaction with a user, a business logic layer in which program segment/module for at least one of image processing and presentation are stored, and a service layer in which program segment/module controlling access to image datasets and reconstruction datasets are stored, further comprising:
a central evaluation device for executing the program segment/module of the business logic layer and the service layer; and
at least one computing device communicating with the central evaluation device for executing the program segment/module of the presentation layer.

14. The method as claimed in claim 1, wherein, the image dataset is a magnetic resonance image dataset.

15. The method as claimed in claim 1, wherein, for a requested presentation outside an original image slice plane, a slice image of the image dataset in an image slice plane lying relatively closest geometrically to the requested presentation plane or the last image slice plane is presented or no presentation is undertaken.

16. The method as claimed in claim 5, wherein the at least one further image dataset is at least one of a computed tomography image dataset, a PET image dataset and a magnetic resonance image dataset.

17. The method as claimed in claim 9, wherein the evaluation tool is a volume determination tool, a movie tool and a manipulation tool.
